(19) United States
(12) Patent Application Publication
(10) Pub. No.: US 2026/0134595 A1
(43) Pub. Date: May 14, 2026

(54) NON-TRANSITORY COMPUTER READABLE MEDIUM

(71) Applicant: TOYOTA JIDOSHA KABUSHIKI KAISHA, Toyota-shi (JP)

(72) Inventor: Wei-hung CHANG, Tokyo-to (JP)

(73) Assignee: TOYOTA JIDOSHA KABUSHIKI KAISHA, Toyota-shi (JP)

(21) Appl. No.: 19/369,673

(22) Filed: Oct. 27, 2025

(30) Foreign Application Priority Data
Nov. 12, 2024 (JP) 2024-197725

(51) Int. Cl. G06T 11/60; G01C 21/36; G06F 3/0482; G06Q 50/40

(52) U.S. Cl. CPC G06T 11/60; G01C 21/3667; G06Q 50/40; G06F 3/0482; G06T 2200/24

(57) ABSTRACT

A terminal apparatus used for sale of transportation tickets overlays, on a map, a first marker indicating an applicable area or applicable line of a selected ticket. Next, the terminal apparatus overlays, on the map, a second marker indicating the current location of a user or a point selected by the user. Then, the terminal apparatus displays, on a screen, a target area on the map, which contains the first marker and/or the second marker.

### CROSS-REFERENCE TO RELATED APPLICATION

This application claims priority to Japanese Patent Application No. 2024-197725, filed on Nov. 12, 2024, the entire contents of which are incorporated herein by reference.

### TECHNICAL FIELD

The present disclosure relates to a non-transitory computer readable medium.

### BACKGROUND

Technology used for transportation tickets is known. For example, Patent Literature (PTL) 1 discloses a system that indicates an available range from the current station based on the balance of an IC card.

### CITATION LIST

### Patent Literature

PTL 1: JP 2014-119840 A

### SUMMARY

Systems used for transportation tickets that allow free travel within specific areas and/or specific periods, such as excursion tickets and one-day passes, indicate available ranges by simply displaying applicable areas/lines on maps, descriptions in text, or the like. However, such methods may make it difficult for people who are not familiar with the areas, such as tourists first visiting from other prefectures or other countries, to grasp the available ranges. Therefore, there is room for improvement with respect to technology used for transportation tickets.

It would be helpful to improve technology used for transportation tickets.

A non-transitory computer readable medium according to a first embodiment of the present disclosure stores a program configured to cause a computer for sale of transportation tickets to execute operations, the operations including:
overlaying, on a map, a first marker indicating an applicable area or applicable line of a selected ticket;
overlaying, on the map, a second marker indicating the current location of a user or a point selected by the user; and
displaying, on a screen, a target area on the map, the target area containing the first marker and/or the second marker.

A non-transitory computer readable medium according to a second embodiment of the present disclosure stores a program configured to cause a computer for sale of transportation tickets to execute operations, the operations including:
displaying the ticket name of a ticket whose applicable area or applicable line contains a point selected on a map; and
overlaying, on the map, a first marker indicating the applicable area or applicable line of the ticket.

A non-transitory computer readable medium according to a third embodiment of the present disclosure stores a program configured to cause a computer for sale of transportation tickets to execute operations, the operations including:
when a destination is input or selected on a map, identifying a ticket available for travel from the current location of a user to the destination; and
displaying a list of the identified ticket, or overlaying, on the map, a first marker indicating an applicable area or applicable line of the ticket identified.

According to the embodiments of the present disclosure, technology used for transportation tickets is improved.

### BRIEF DESCRIPTION OF THE DRAWINGS

In the accompanying drawings:

FIG. 1 is a block diagram illustrating a schematic configuration of a system according to embodiments of the present disclosure;

FIG. 2 is a block diagram illustrating a schematic configuration of a terminal apparatus;

FIG. 3 is a block diagram illustrating a schematic configuration of an information processing apparatus;

FIG. 4 is a flowchart illustrating operations of the information processing apparatus according to a first embodiment;

FIG. 5 is a flowchart illustrating operations of the information processing apparatus according to a second embodiment;

FIG. 6 is a flowchart illustrating operations of the information processing apparatus according to a third embodiment;

FIG. 7A is an example of a screen image diagram of the present disclosure;

FIG. 7B is an example of a screen image diagram of the present disclosure;

FIG. 7C is an example of a screen image diagram of the present disclosure;

FIG. 7D is an example of a screen image diagram of the present disclosure;

FIG. 8A is an example of a screen image diagram of the present disclosure;

FIG. 8B is an example of a screen image diagram of the present disclosure;

FIG. 8C is an example of a screen image diagram of the present disclosure; and

FIG. 8D is an example of a screen image diagram of the present disclosure.

### DETAILED DESCRIPTION

Hereinafter, embodiments of the present disclosure will be described.

### Outline of Embodiments

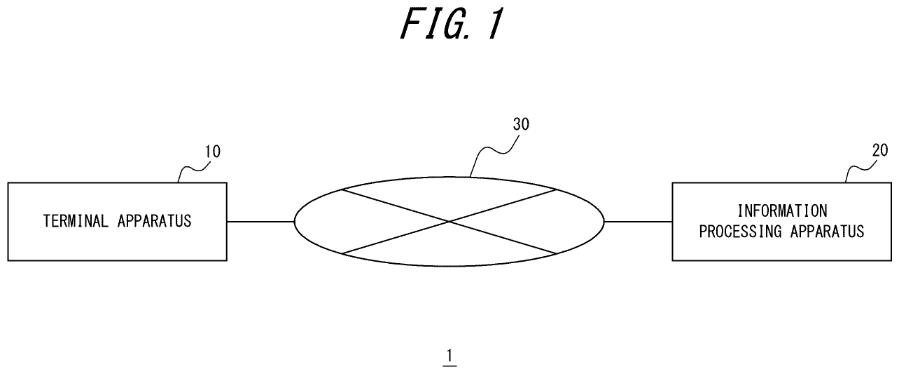

An outline of a system 1 according to the embodiments of the present disclosure will be described with reference to FIG. 1. The system 1 includes a plurality of terminal apparatuses 10 and an information processing apparatus 20. Each terminal apparatus 10 and the information processing apparatus 20 are communicably connected to a network 30 including, for example, the Internet, a mobile communication network, or the like.

The terminal apparatuses 10 are computers, such as personal computers (PCs), smartphones, or tablet terminals.

The information processing apparatus 20 is one computer, e.g., a server apparatus, or a plurality of computers, e.g., server apparatuses that can communicate with each other. The information processing apparatus 20 can communicate with each terminal apparatus 10 via the network 30.

First, an outline of the present embodiments will be described, and details thereof will be described later. The terminal apparatus 10 according to a first embodiment for sale of transportation tickets overlays, on a map, a first marker indicating an applicable area or applicable line of a selected ticket. Next, the terminal apparatus 10 overlays, on the map, a second marker indicating the current location of a user or a point selected by the user. Then, the terminal apparatus 10 displays, on a screen, a target area on the map, which contains the first marker and/or the second marker.

The terminal apparatus 10 according to a second embodiment for sale of transportation tickets displays the ticket name of a ticket whose applicable area or applicable line contains a point selected on a map. Then, the terminal apparatus 10 overlays, on the map, a first marker indicating an applicable area or applicable line of the ticket.

The terminal apparatus 10 according to a third embodiment for sale of transportation tickets identifies a ticket available for travel from the current location of a user to a destination when the destination is input or selected on a map. Then, the terminal apparatus 10 displays a list of the identified ticket, or overlays, on the map, a first marker indicating an applicable area or applicable line of the ticket identified.

Systems used for flat-rate transportation tickets that allow free travel within specific areas and/or specific periods, such as excursion tickets and one-day passes, indicate available ranges by simply displaying applicable areas/lines on maps, descriptions in text, or the like. However, such methods may make it difficult for people who are not familiar with the areas, such as tourists first visiting from other prefectures or other countries, to grasp the available ranges. In contrast, according to the first embodiment, the first marker indicating the applicable area or applicable line of the ticket and the second marker indicating the current location of the user or the point selected by the user are overlaid on the map. This makes it possible for the user to grasp the applicable area or applicable line of the ticket to be purchased, with respect to the current location of the user, thus avoiding erroneous purchase before purchasing the ticket, and improving convenience after purchasing. According to the second embodiment, the first marker indicating the applicable area or applicable line of the ticket, whose applicable area or applicable line contains the point selected by the user on the map, is overlaid on the map. This makes it possible for the user to accurately grasp whether there is a ticket available in a desired area and, when there is a ticket, an applicable range of the ticket. According to the third embodiment, when the user inputs the destination or selects the destination on the map, the list of the ticket available for travel to the destination is displayed, or the first marker indicating the applicable area or applicable line is overlaid on the map. This makes it possible for the user to check whether there is a ticket available from the current location to the destination. Thus, according to the present embodiments, technology used for transportation tickets that allow free travel within specific areas and/or specific periods is improved in that it becomes easier for users to grasp applicable areas or applicable lines of the transportation tickets.

Next, configurations of the system 1 will be described in detail.

### Configuration of Terminal Apparatus

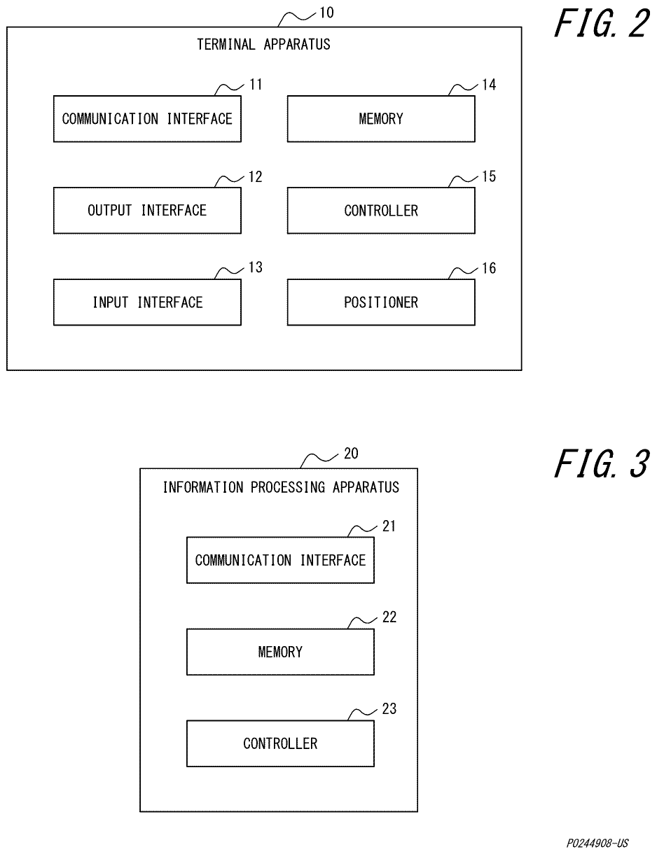

As illustrated in FIG. 2, each terminal apparatus 10 includes a communication interface 11, an output interface 12, an input interface 13, a memory 14, a controller 15, and a positioner 16.

The communication interface 11 includes at least one communication interface for connecting to the network 30. The communication interface is compliant with a mobile communication standard such as the 4th generation (4G) standard or the 5th generation (5G) standard, for example, but is not limited to these. In the present embodiments, the terminal apparatus 10 communicates with the information processing apparatus 20 via the communication interface 11 and the network 30.

The output interface 12 includes at least one output device for outputting information. The output device is, for example, a display for outputting information as video, a speaker for outputting information as audio, or the like, but is not limited to these. Alternatively, the output interface 12 may include an interface for connecting to an external output device.

The input interface 13 includes at least one input device for detecting an input operation by a user. The input device is, for example, a physical key, a capacitive key, a mouse, a touch panel, a touch screen integrally provided with a display of the output interface 12, a microphone, or the like, but is not limited to these. Alternatively, the input interface 13 may include an interface for connecting to an external input device.

The memory 14 includes one or more memories. The memories are, for example, semiconductor memories, magnetic memories, optical memories, or the like, but are not limited to these. The memories included in the memory 14 may each function as, for example, a main memory, an auxiliary memory, or a cache memory. The memory 14 stores any information to be used for operations of the terminal apparatus 10. For example, the memory 14 may store a system program, an application program, embedded software, and the like. For example, the information stored in the memory 14 may be updated with, for example, information acquired from the network 30 via the communication interface 11.

The controller 15 includes at least one processor, at least one programmable circuit, at least one dedicated circuit, or a combination of these. The processor is, for example, a general purpose processor such as a central processing unit (CPU) or a graphics processing unit (GPU), or a dedicated processor that is dedicated to specific processing, but is not limited to these. The programmable circuit is a field-programmable gate array (FPGA), for example, but is not limited to this. The dedicated circuit is an application specific integrated circuit (ASIC), for example, but is not limited to this. The controller 15 controls operations of the entire terminal apparatus 10.

The positioner 16 includes at least one device for acquiring positional information on the terminal apparatus 10. Specifically, the positioner 16 is, for example, a position sensor corresponding to a global positioning system (GPS) or the like, a geomagnetic sensor, a velocity sensor, an acceleration sensor, a gyro sensor, or the like, but is not limited to these and may be any sensor.

### Configuration of Information Processing Apparatus

As illustrated in FIG. 3, the information processing apparatus 20 includes a communication interface 21, a memory 22, and a controller 23.

The communication interface 21 includes at least one communication interface for connecting to the network 30. The communication interface is compliant with, for example, but not limited to, a mobile communication standard, a wired local area network (LAN) standard, or a wireless LAN standard, and may be compliant with any appropriate communication standard. In the present embodiments, the information processing apparatus 20 communicates with each terminal apparatus 10 via the communication interface 21 and the network 30.

The memory 22 includes one or more memories. The memories included in the memory 22 may each function as, for example, a main memory, an auxiliary memory, or a cache memory. The memory 22 stores any information to be used for operations of the information processing apparatus 20. For example, the memory 22 may store a system program, an application program, embedded software, map information, and the like.

The controller 23 includes at least one processor, at least one programmable circuit, at least one dedicated circuit, or a combination of these. The processor is, for example, a general purpose processor such as a central processing unit (CPU) or a graphics processing unit (GPU), or a dedicated processor that is dedicated to specific processing, but is not limited to these. The programmable circuit is a field-programmable gate array (FPGA), for example, but is not limited to this. The dedicated circuit is an application specific integrated circuit (ASIC), for example, but is not limited to this. The controller 23 controls operations of the entire information processing apparatus 20.

### First Operation Flow of Terminal Apparatus

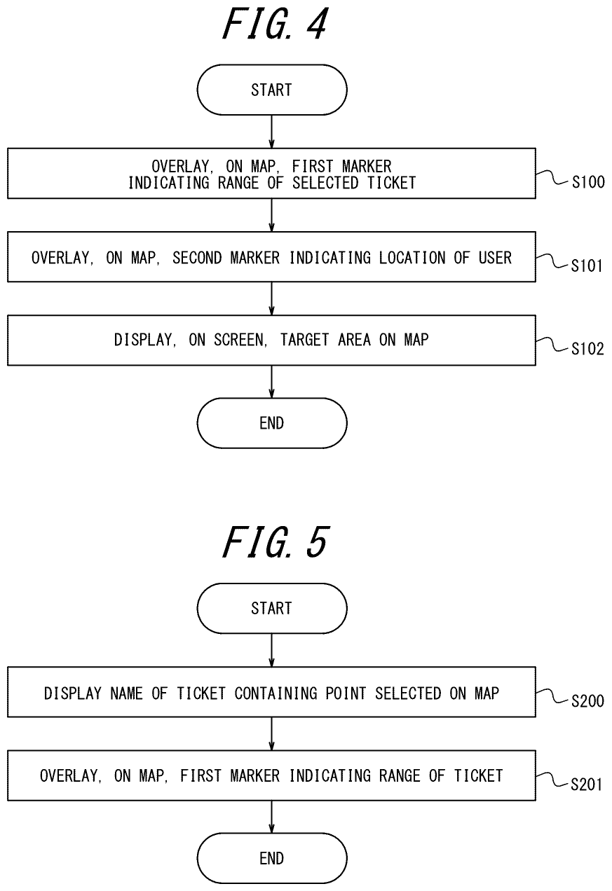

Operations of the terminal apparatus 10 according to the first embodiment will be described with reference to FIG. 4.

S100: The controller 15 of the terminal apparatus 10 overlays, on a map, a first marker indicating an applicable area or applicable line of a selected ticket.

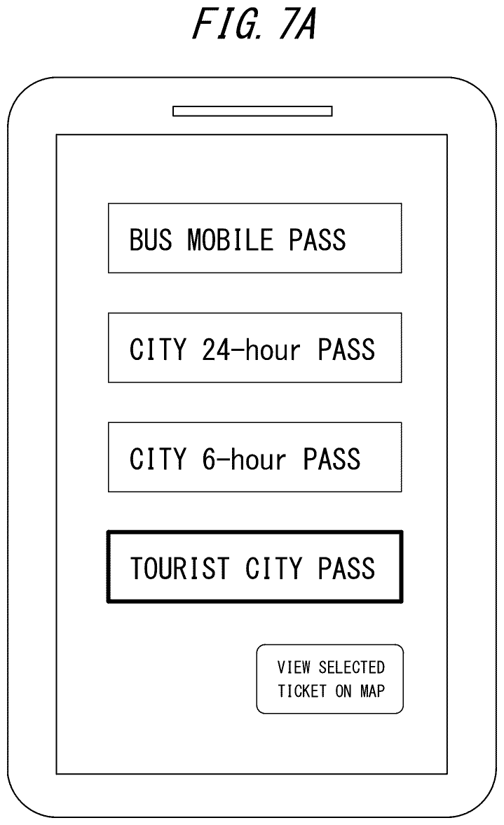

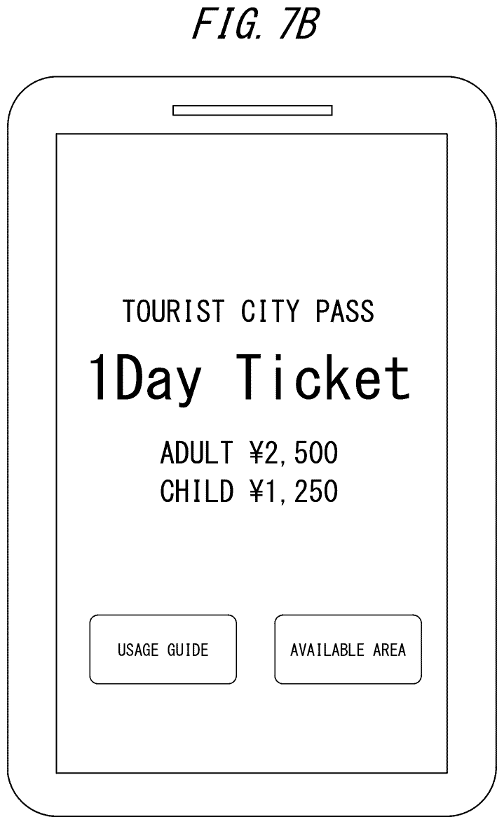

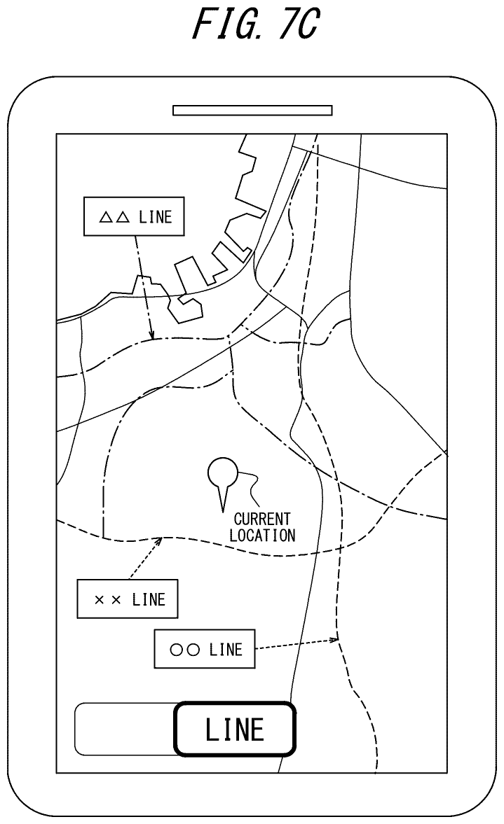

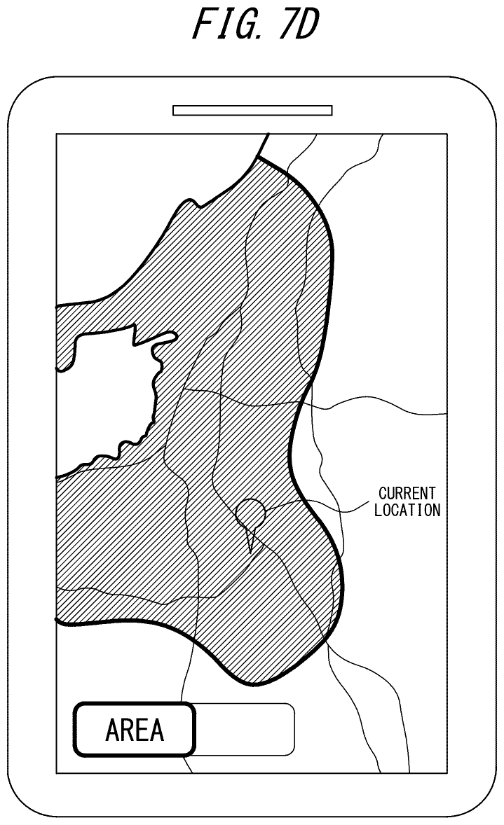

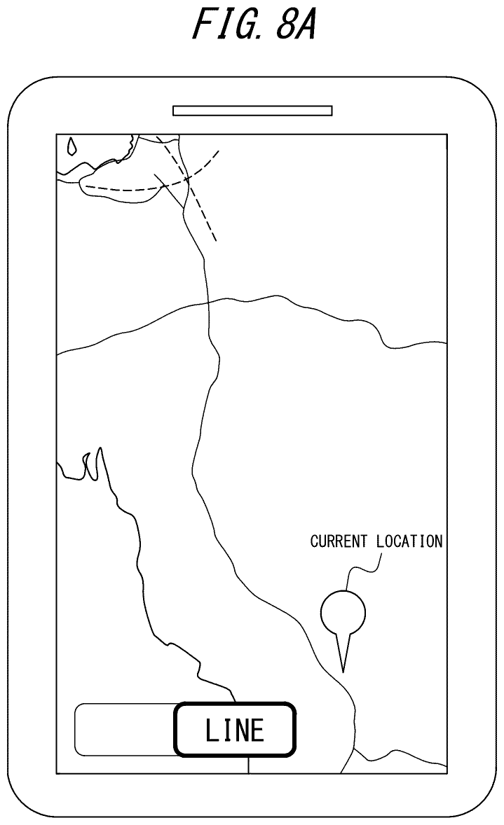

Specifically, for example, as illustrated in FIG. 7A, the controller 15 displays a list of transportation tickets on a screen of a display of the output interface 12. When a user selects a ticket on the screen, the controller 15 acquires ticket information on the selected ticket, which is stored in the memory 14 or the memory 22 of the information processing apparatus 20. The ticket information includes information on an applicable area or applicable line of the ticket. Then, the controller 15 overlays a first marker indicating the applicable area or applicable line of the ticket selected by the user, on a map according to map information stored in the memory 14 or the memory 22 of the information processing apparatus 20. Alternatively, the controller 15 may overlay a first marker indicating the applicable area or applicable line of the selected ticket on a map, for example, by pressing a button that is displayed on that screen to view the applicable area or applicable line of the ticket. Alternatively, the controller 15 may overlay a first marker indicating the applicable area or applicable line of the selected ticket on a map, for example, by pressing, from a screen displaying the details of a specific ticket, as illustrated in FIG. 7B, a button to view an applicable area or applicable line of that ticket on the map.

For the applicable area, the first marker may be highlighted display by color in which, for example, the applicable area is highlighted in yellow, or may be patterned display in which the applicable area is patterned with dots or stripes, but is not limited to these and may be any marker. For the applicable line, the first marker may be a change of the color of a line, the type of the line to a solid line, a dotted line, or the like, and/or the thickness of the line, or a combination of these, such as the applicable line highlighted with a bold red line, but may be any marker not limited to these. When there is a plurality of applicable lines, first markers for the respective applicable lines may be in different forms, e.g., using different colors.

The “list of tickets” may be filtered by a plurality of conditions, such as a region and a transportation means. The controller 15 may acquire information on tickets that match the plurality of conditions specified by the user, from ticket information stored in the memory 14 or the memory 22 of the information processing apparatus 20, and display a list of the tickets.

The “ticket information” may include a ticket name, a ticket price, an applicable range, an applicable line, an applicable transportation means, and a validity period, but may also include any ticket information not limited to these.

The controller 15 may display the ticket name of the selected ticket on the map.

S101: The controller 15 overlays, on the map, a second marker indicating the current location of the user or a point selected by the user.

Specifically, the controller 15 identifies the current location of the user, by acquiring the current location of the terminal apparatus 10 using the positioner 16. Then, the controller 15 overlays a second marker indicating the current location of the user, on the map according to the map information, as in S100. Alternatively, the controller 15 may overlays, on the map, a second marker indicating a point that is selected by the user from the map displayed on the screen using, for example, a touch panel of the input interface 13.

The second marker may be in any color, such as red, or any shape, such as a circle, or may be a combination of these, but may be a marker in any form not limited to this.

S102: The controller 15 displays, on the screen, a target area on the map that contains the first marker and/or the second marker.

Specifically, for example, when the current location of the user is contained in a target area of the selected ticket, the controller 15 displays, on the screen, the target area on the map, which contains the first marker and the second marker, as illustrated in FIG. 7C or FIG. 7D.

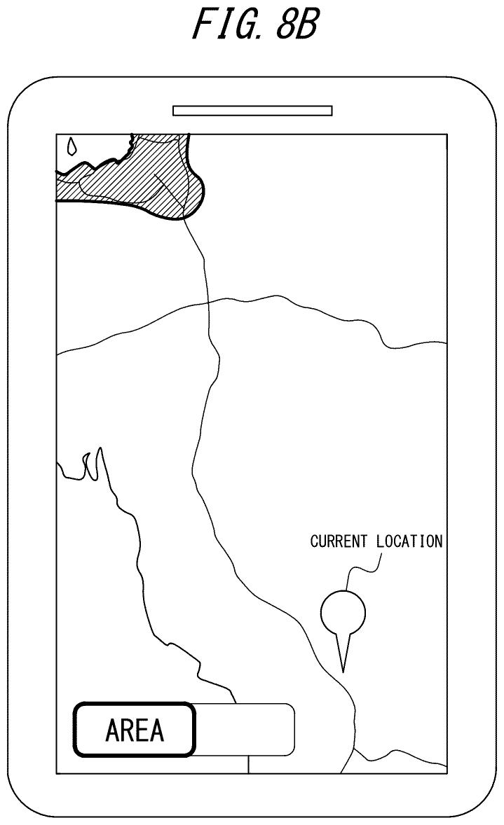

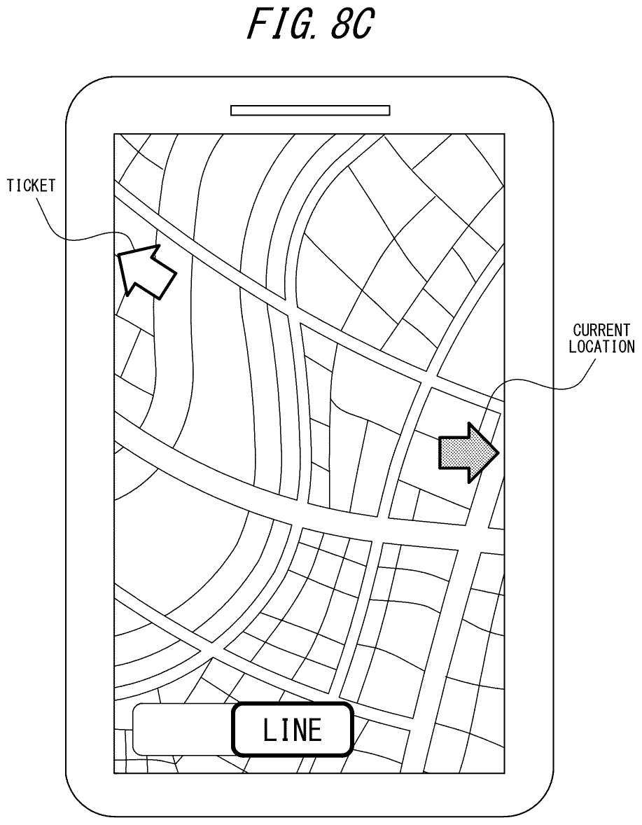

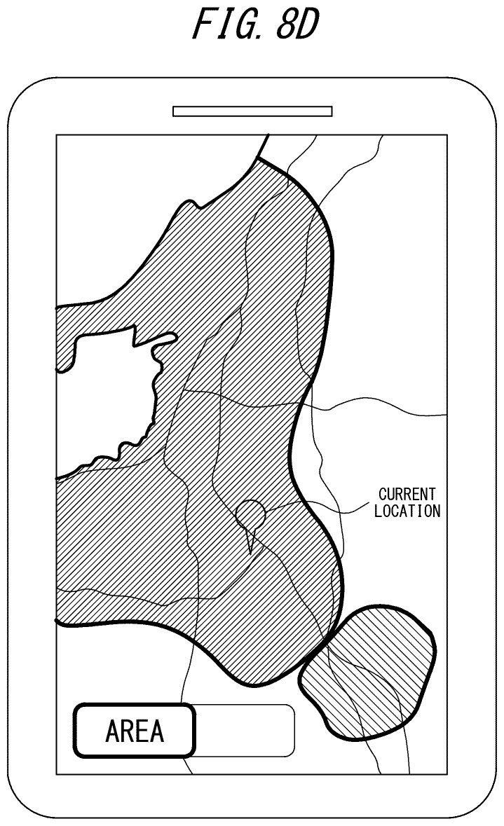

For example, assuming that the current location of the user is not contained in the target area of the selected ticket. In this case, the controller 15 may automatically change the scale of the map to a different scale from that of FIG. 7C or FIG. 7D, so that both the first marker and the second marker are displayed on the screen, as illustrated in FIG. 8A or FIG. 8B. Alternatively, the controller 15 may display only the first marker on the screen, or display only the second marker on the screen. When the first marker or the second marker is not displayed on the screen, the controller 15 may display, on the screen, information indicating a direction from a predetermined point on the map displayed on the screen to the first marker or the second marker that is not displayed on the screen. For example, when the first marker is not displayed on the screen, the controller 15 may display, on the screen, a graphic such as an arrow indicating a direction from the second marker on the map, which is displayed on the screen, to the first marker, which is not displayed on the screen. When the second marker is not displayed on the screen, the controller 15 may display a graphic such as an arrow indicating a direction from the first marker on the map, which is displayed on the screen, to the second marker, which is not displayed on the screen. This makes it possible for the user to grasp the target area of the ticket or the direction of the own location, relative to the position on the map, even when the target area of the ticket or the location of the user is not present on the map currently displayed.

When the controller 15 automatically changes the scale of the map so that both the first marker and the second marker are displayed on the screen, the controller 15 may determine whether to display the first marker and the second marker on the screen based on whether the scale is greater than a predetermined value. Specifically, when the scale is greater than or equal to the predetermined value, the controller 15 may automatically change the scale of the map so that both the first marker and the second marker are displayed on the screen. When the scale is less than the predetermined value, the controller 15 may display, on the screen, a target area on the map that contains any one of the first marker or the second marker. In this case, as in the above processing, the controller 15 may display, on the screen, a graphic such as an arrow indicating a direction from one point of the first marker or the second marker contained in the map to the other point that is not contained in the map. When the scale is too small, it becomes difficult for the user to grasp the applicable area or applicable line of the ticket, or the relationship between the current location of the user and the applicable area of the ticket. However, such processing can eliminate this problem. Note that, the predetermined value of the scale may be changeable.

The controller 15 may determine whether to display the first marker and the second marker on the screen, based on whether the first marker and the second marker belong to a predetermined area. Specifically, when the first marker and the second marker belong to a predetermined area, the controller 15 may automatically change the scale of the map so that both the first marker and the second marker are displayed on the screen. When the first marker and the second marker do not belong to the predetermined area, the controller 15 may display, on the screen, a target area on the map that contains any one of the first marker or the second marker. In this case, as in the above processing, the controller 15 may display, on the screen, a graphic such as an arrow indicating a direction from one point of the first marker or the second marker contained in the map to the other point that is not contained in the map.

The “predetermined area” may be a region, such as Japan, Asia, or the Kanto region, that can be a scale of the map in which the user can grasp the applicable area or applicable line of the ticket or the relationship between the current location of the user and the applicable area of the ticket. The predetermined area may be changeable.

The area (displayed area) on the map to be displayed on the screen may be changeable, for example, by the user scrolling the screen. When, as a result of scrolling the screen, the first marker or the second marker is not displayed on the screen, the controller 15 may display a graphic such as an arrow indicating a direction from one point of the first marker or the second marker contained in the map to the other point that is not contained in the map, as with the above processing. When neither the first marker nor the second marker is displayed on the screen, the controller 15 may display graphics such as arrows indicating directions from the center of the map displayed on the screen to the first marker and the second marker, as illustrated in FIG. 8C. In this case, for example, as illustrated in FIG. 8C, the graphics to the respective markers may be in different forms, such as a normal arrow indicating the direction to the first marker, and a dot-pattern arrow indicating the direction to the second marker.

### Second Operation Flow of Terminal Apparatus

Next, operations of the terminal apparatus 10 according to the second embodiment will be described with reference to FIG. 5.

S200: The controller 15 displays the ticket name of a ticket whose applicable area or applicable line contains a point selected on a map.

Specifically, the controller 15 detects that a specific point has been selected by a user from a map displayed on a screen using, for example, a touch panel of the input interface 13. Next, the controller 15 acquires, from the memory 14 or the memory 22 of the information processing apparatus 20, ticket information whose applicable area or applicable line contains the selected point. Then, the controller 15 displays, on the screen, a ticket name included in the acquired ticket information.

S201: The controller 15 overlays, on the map, a first marker indicating the applicable area or applicable line of the ticket.

Specifically, the controller 15 acquires the applicable area or applicable line of the ticket included in the ticket information acquired in S200. Then, the controller 15 overlays, on the map, a first marker indicating the applicable area or applicable line of the ticket.

### Third Operation Flow of Terminal Apparatus

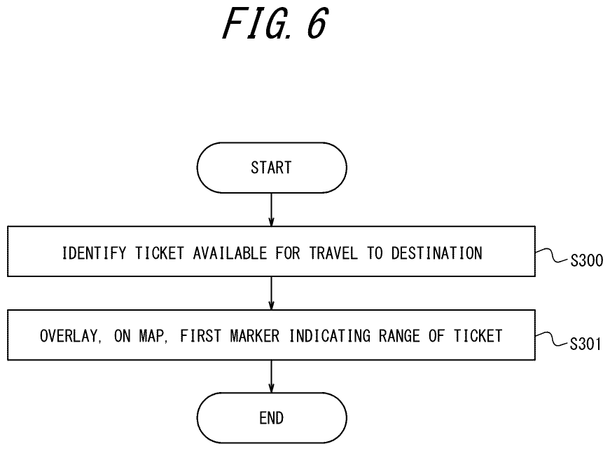

Next, operations of the terminal apparatus 10 according to the third embodiment will be described with reference to FIG. 6.

S300: When a destination is input or selected on a map, the controller 15 identifies a ticket available for travel from the current location of a user to the destination.

Specifically, for example, when a destination is input from an input form on a screen, or when a destination is selected by a user on a map displayed on a screen, the controller 15 identifies the current location of the user by acquiring the current location of the terminal apparatus 10 using the positioner 16. Next, the controller 15 identifies areas and lines included in a route from the current location of the user to the destination, based on map information stored in the memory 14 or the memory 22 of the information processing apparatus 20. Then, the controller 15 identifies a ticket whose ticket information includes the identified areas or lines.

S301: The controller 15 displays a list of the identified ticket, or overlays, on the map, a first marker indicating an applicable area or applicable line of the identified ticket.

Specifically, the controller 15 displays a list of the ticket identified in S300, e.g., a list of transportation tickets as illustrated in FIG. 7A, on a screen of a display of the output interface 12. Alternatively, the controller 15 overlays, on the map, a first marker indicating an applicable area or applicable line of the identified ticket.

When the first marker indicating the applicable area or applicable line of the identified ticket is overlaid on the map, the controller 15 may display the ticket name of that ticket on the map.

When the list of the transportation tickets is displayed, the controller 15 may continuously perform the operations according to the first embodiment.

As described above, the terminal apparatus 10 according to the first embodiment for sale of transportation tickets overlays, on a map, a first marker indicating an applicable area or applicable line of a selected ticket. Next, the terminal apparatus 10 overlays, on the map, a second marker indicating the current location of a user or a point selected by the user. Then, the terminal apparatus 10 displays, on a screen, a target area on the map, which contains the first marker and/or the second marker.

The terminal apparatus 10 according to the second embodiment for sale of transportation tickets displays the ticket name of a ticket whose applicable area or applicable line contains a point selected on a map. Then, the terminal apparatus 10 overlays, on the map, a first marker indicating an applicable area or applicable line of the ticket.

The terminal apparatus 10 according to the third embodiment for sale of transportation tickets identifies a ticket available for travel from the current location of a user to a destination when the destination is input or selected on a map. Then, the terminal apparatus 10 displays a list of the identified ticket, or overlays, on the map, a first marker indicating an applicable area or applicable line of the ticket identified.

According to the first embodiment with such a configuration, the first marker indicating the applicable area or applicable line of the ticket and the second marker indicating the current location of the user or the point selected by the user are overlaid on the map. This makes it possible for the user to grasp the applicable area or applicable line of the ticket to be purchased, with respect to the current location of the user, thus avoiding erroneous purchase before purchasing the ticket, and improving convenience after purchasing. According to the second embodiment, the first marker indicating the applicable area or applicable line of the ticket, whose applicable area or applicable line contains the point selected by the user on the map, is overlaid on the map. This makes it possible for the user to accurately grasp whether there is a ticket available in a desired area and, when there is a ticket, an applicable range of the ticket. According to the third embodiment, when the user inputs the destination or selects the destination on the map, the list of the ticket available for travel to the destination is displayed, or the first marker indicating the applicable area or applicable line is overlaid on the map. This makes it possible for the user to check whether there is a ticket available from the current location to the destination. Thus, according to the present embodiments, technology used for transportation tickets that allow free travel within specific areas and/or specific periods is improved in that it becomes easier for users to grasp applicable areas or applicable lines of the transportation tickets.

The functions of the terminal apparatus 10 are realized by executing a program by a processor serving as the controller 15. That is, the functions of the terminal apparatus 10 are realized by software. The program causes a computer to execute the operations of the terminal apparatus 10, thereby causing the computer to function as the terminal apparatus 10. That is, the computer executes the operations of the terminal apparatus 10 in accordance with the program to thereby function as the terminal apparatus 10.

The program can be stored on a non-transitory computer readable medium. The non-transitory computer readable medium is, for example, a flash memory, a magnetic recording device, an optical disc, a magneto-optical recording medium, or a read only memory (ROM). The program is distributed, for example, by selling, transferring, or lending a portable medium such as a digital versatile disc (DVD) or a compact disc read only memory (CD-ROM) on which the program is stored. The program may be distributed by storing the program in a storage of a server and transferring the program from the server to another computer. The program may be provided as a program product.

While the present disclosure has been described with reference to the drawings and examples, it should be noted that various modifications and revisions may be implemented by those skilled in the art based on the present disclosure. Accordingly, such modifications and revisions are included within the scope of the present disclosure. For example, functions or the like contained in each component, each step, or the like can be rearranged without logical inconsistency, and a plurality of components, steps, or the like can be combined into one or divided.

For example, in the embodiments described above, embodiments in which the configuration and operations of the terminal apparatus 10 are distributed to multiple computers capable of communicating with each other are also possible. For example, embodiments in which some or all of the components of the terminal apparatus 10 are provided in the information processing apparatus 20 are also possible. For example, the information processing apparatus 20 may include some or all of the components of the terminal apparatus 10.

For example, in any of the embodiments described above, the controller 15 may switch, in response to an operation of the user, a target indicated by the first marker between the applicable area and the applicable line.

Specifically, the controller 15 may provide, on the screen, any interface such as a tab for switching between the applicable area and the applicable line, as illustrated in FIG. 7C and FIG. 7D. When an interface for indicating the applicable area is selected by the user, the controller 15 overlays, on the map, a first marker indicating the applicable area, as illustrated in FIG. 7D. When an interface for indicating the applicable line is selected by the user, the controller 15 overlays, on the map, a first marker indicating the applicable line, as illustrated in FIG. 7C. This can improve the convenience of the user. The controller 15 may provide, on the screen, an interface to indicate both the applicable area and the applicable line of the ticket.

For example, in any of the embodiments described above, when the ticket name displayed on the screen is selected by the user, the controller 15 may switch from the map screen to a screen indicating the details of the ticket.

Specifically, in a case in which the ticket name of the ticket whose applicable area or applicable line is indicated on the map is displayed, when the ticket name is selected by the user, the controller 15 may switch to a screen indicating the details of the ticket, as illustrated in FIG. 7B. This can improve the convenience of the user.

For example, in the first embodiment described above, when a plurality of tickets is selected, the controller 15 may display first markers of the respective tickets in different display forms.

Specifically, when a plurality of tickets are selected by the user from the list of the tickets in S100, the controller 15 may use different stripe patterns for the respective tickets, such as one with a dark stripe pattern and another with a light stripe pattern, as illustrated in FIG. 8D. The different display forms may be achieved by different colors, line thicknesses, line types, but may be any display forms not limited to these. This allows the user to grasp applicable areas or applicable lines of the plurality of tickets simultaneously.

The variation described above may also be applied when, in the second embodiment, ticket information for a plurality of tickets is acquired. The variation described above may also be applied when, in the third embodiment, a plurality of tickets is identified and first markers indicating applicable areas or applicable lines of the identified tickets are overlaid on the map.

For example, in the second and third embodiments described above, the controller 15 may execute S101 and S102. This allows the user to grasp the applicable area or applicable line of the ticket to be purchased, with respect to the current location of the user, even in the second and third embodiments.

For example, in any of the embodiments described above, when the ticket includes service that provides a benefit at a specific facility, the controller 15 may overlay, on the map, a third marker indicating that facility.

Specifically, the controller 15 acquires the presence or absence of a benefit at a specific facility included in the ticket information stored in the memory 14 or the memory 22 of the information processing apparatus 20. When there is a benefit at a specific facility, the controller 15 overlays, on the map, a third marker indicating that facility. When there is a plurality of facilities, the controller 15 may overlay a third marker for each of the plurality of facilities. This allows the user not only to grasp the applicable area or applicable line of the ticket but also to grasp a specific facility when there is a benefit at that facility.

The third marker may be in any color, such as red, or any shape, such as a rectangle, or may be a combination of these, but may be a marker in any form not limited to these.

For example, embodiments in which a general purpose computer functions as the terminal apparatus 10 according to the above embodiments can also be implemented. Specifically, programs in which processes for realizing the functions of the terminal apparatus 10 according to the above embodiments are written may be stored in a memory of a general purpose computer, and the programs may be read and executed by a processor. Accordingly, the present disclosure can also be implemented as programs executable by a processor, or non-transitory computer readable mediums storing the programs.

1. A non-transitory computer readable medium storing a program configured to cause a computer for sale of transportation tickets to execute operations, the operations comprising:
overlaying, on a map, a first marker indicating an applicable area or applicable line of a selected ticket;
overlaying, on the map, a second marker indicating a current location of a user or a point selected by the user; and
displaying, on a screen, a target area on the map, the target area containing the first marker and/or the second marker.

2. The non-transitory computer readable medium according to claim 1, wherein the operations further comprise, when the first marker or the second marker is not displayed on the screen, displaying, on the screen, information indicating a direction from a predetermined point on the map displayed on the screen to the first marker or the second marker that is not displayed on the screen.

3. The non-transitory computer readable medium according to claim 1, wherein the operations further comprise switching, in response to an operation of the user, a target indicated by the first marker between the applicable area and the applicable line.

4. The non-transitory computer readable medium according to claim 1, wherein the operations further comprise, when a plurality of tickets is selected, displaying first markers for the respective tickets in different display forms.

5. A non-transitory computer readable medium storing a program configured to cause a computer for sale of transportation tickets to execute operations, the operations comprising:
displaying a ticket name of a ticket whose applicable area or applicable line contains a point selected on a map; and
overlaying, on the map, a first marker indicating the applicable area or applicable line of the ticket.

6. A non-transitory computer readable medium storing a program configured to cause a computer for sale of transportation tickets to execute operations, the operations comprising:
when a destination is input or selected on a map, identifying a ticket available for travel from a current location of a user to the destination; and
displaying a list of the identified ticket, or overlaying, on the map, a first marker indicating an applicable area or applicable line of the ticket identified.
